(19) United States
(12) Patent Application Publication
(10) Pub. No.: US 2007/0150073 A1
(43) Pub. Date: Jun. 28, 2007

(54) Asset management system

(76) Inventor: Jay Dawson, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/315,323

(22) Filed: Dec. 23, 2005

(51) Int. Cl. G05B 11/01

(52) U.S. Cl. 700/11

(57) ABSTRACT

An asset management system is provided. The system may include one or more data collection devices configured to monitor one or more operating conditions of a machine in real time. The system may also include a processor configured to receive data from the one or more data collection devices and perform an analysis of the received data as it relates to a set of usage terms of a service contract relating to the machine. The system may also be configured to communicate, in real time, at least one of data received from the one or more data collection devices and the analysis of the received data to at least one location remote from the machine. The system may be further configured to communicate, in real time, to at least one of an owner and an operator, information regarding at least one of the received data and the analysis of the received data.

### TECHNICAL FIELD

The present disclosure is directed to an asset management system and, more particularly, to an asset management system based on machine data acquisition.

### BACKGROUND

Over time, machines have become more and more technologically sophisticated. The evolution of computing technology, among other things, has spawned the development of better performing machines by facilitating more control of machine operating systems. Improved control may be enabled, in some cases, by monitoring the operating parameters of a system or component in “real time.” Such monitoring may enable a system to respond in a precise and virtually immediate manner to maintain operating parameters within desired specifications.

Machine owners may be concerned with various aspects of machine operation, such as machine performance, operator conduct (e.g., abuse, productivity, etc.), efficiency, machine health, etc. In some cases, such as with machines under a service contract, the administrator of such a contract may be particularly concerned with operator compliance with usage terms of the contract. The same or similar types of monitoring equipment that are used to regulate performance of a machine may also be used to record operating conditions data that may be used to monitor the various aspects of machine operation mentioned above. Data acquisition such as this may be used to determine how much or in what way a machine is being used.

Systems have been developed that make use of such data acquisition in providing service contracts. For example, U.S. Patent Publication No. 2002/0065698 to Schick et al. (“the '698 publication”), discloses facilitating administration of service contracts by utilizing collection of real time machine operation data. The '698 publication also discloses communication of information regarding the data acquisition in real time.

While the '698 publication may disclose communication of information regarding the data acquisition in real time, the '698 publication does not disclose doing so when the data and/or analysis has been communicated to an entity or location remote from the machine. Rather, the '698 publication discloses real time communication of data and/or analysis to an operator of the machine when the analysis is performed onboard the machine. Remote processing may enable a broader range of analysis to be performed on the data, as well as permit monitoring by one or more entity. In addition, remote processing may enable more sophisticated feedback to be developed, which may be communicated back to the operator and/or owner.

The present disclosure is directed to overcoming one or more of the problems set forth above.

### SUMMARY OF THE INVENTION

In one aspect, the present disclosure is directed to an asset management system. The system may include one or more data collection devices configured to monitor one or more operating conditions of a machine in real time. The system may also include a processor configured to receive data from the one or more data collection devices and perform an analysis of the received data as it relates to a set of usage terms of a service contract relating to the machine. The system may also be configured to communicate, in real time, at least one of data received from the one or more data collection devices and the analysis of the received data to at least one location remote from the machine. The system may be further configured to communicate, in real time, to at least one of an owner and an operator, information regarding at least one of the received data and the analysis of the received data.

In another aspect, the present disclosure is directed to a method of asset management. The method may include monitoring one or more operating conditions of a machine in real time and receiving data from the one or more data collection devices. The method may further include performing an analysis of the received data including making a comparison between the received data and a set of usage terms of a service contract relating to the machine. The method may also include communicating, in real time, at least one of the data received from the one or more data collection devices and the analysis of the received data to at least one location remote from the machine. In addition, the method may include communicating, in real time, to at least one of an owner and an operator, information regarding at least one of the received data and the analysis of the received data.

### BRIEF DESCRIPTION OF THE DRAWINGS

FIG. 1 is a diagrammatic illustration of an asset management system according to an exemplary disclosed embodiment.

FIG. 2 is a block diagram representation of an asset management system according to an exemplary disclosed embodiment.

### DETAILED DESCRIPTION

Reference will now be made in detail to the drawings. Wherever possible, the same reference numbers will be used throughout the drawings to refer to the same or like parts.

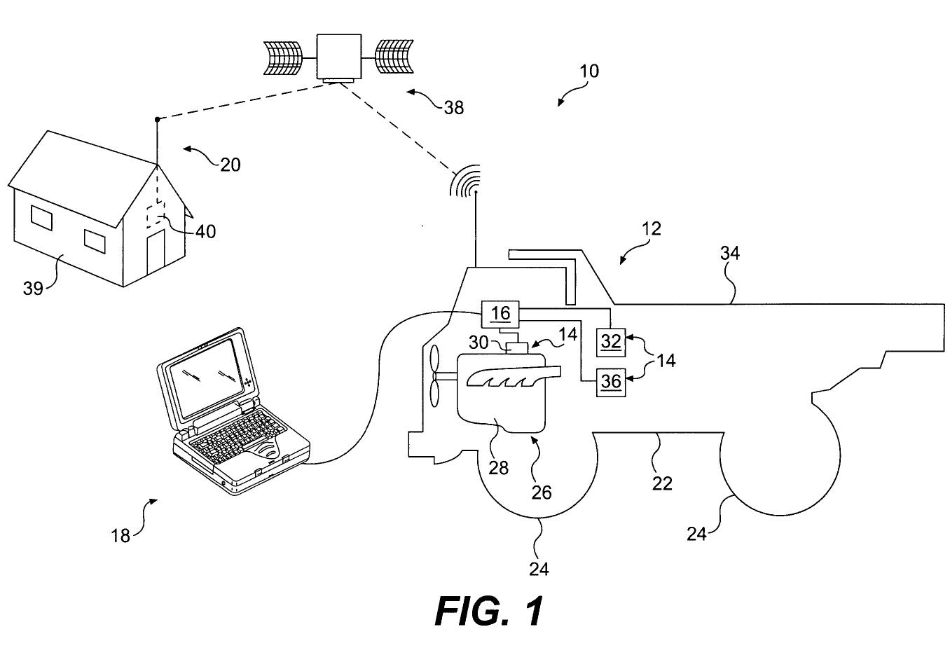

FIG. 1 shows an asset management system 10. System 10 may include a machine 12. System 10 may also include data collection devices 14, a controller 16, and a means for offloading data from machine 12. Such means may include, for example, a hardware interface device 18 or an over-the-air transmission receiving device 20.

Machine 12 may include a frame 22, one or more traction devices 24, and a power source 26. Although machine 12 is shown as a truck, machine 12 could be any type of machine. Accordingly, traction devices 24 may be any type of traction devices, such as, for example, wheels, as shown in FIG. 1, tracks, belts, or any combinations thereof.

Power source 26 may include any type of power source. Power source 26 is illustrated as an internal combustion engine 28. Power source 26 may include any type of internal combustion engine, such as gasoline engines, diesel engines, natural gas engines, etc. Although power source 26 is illustrated as an internal combustion engine, alternatively, power source 26 could include other types of power sources such as a fuel cell or an electrical power source, such as a battery. Power source 26 could also include a hybrid power system, combining, for example, an internal combustion engine with a battery.

Data collection devices 14 may include any kind of sensors or other types of monitoring equipment suitable for monitoring one or more operating conditions of machine 12. In some embodiments, data collection devices 14 may be configured to monitor operating conditions that are indicative of the harshness with which machine 12 is operated. In one aspect, data collection devices 14 may be configured to monitor one or more operating parameters of machine 12. For example, system 10 may include an engine monitoring device 30 configured to monitor one or more operating parameters of engine 28. Exemplary engine operating parameters that may be monitored by engine monitoring device 30 include engine hours (i.e., the amount of time the engine runs), engine speed and idle time, as well as harshness indicators, such as engine load, etc.

Data collection devices 14 may also include other equipment for monitoring other operating parameters of machine 12. For example, machine 12 may include a work implement sensor 32. Work implement sensor 32 could be any type of sensor for monitoring the operation of a work tool, such as a bucket, blade, claw, etc. Work implement sensor 32 may be configured to monitor the number of times (repetitions), speed, and/or the load at which a work implement is operated. As shown in FIG. 1, work implement sensor 32 may be configured to monitor the operation of a dump body 34 of machine 12. For example, work implement sensor 32 may be configured to monitor the number of times and/or the speed at which dump body 34 is raised and lowered. Data collected from such monitoring may indicate harshness of operation of machine 12.

Data collection devices 14 may also include other equipment for monitoring other aspects of machine 12, such as transmissions, suspension, and actuators. Other aspects that may be monitored to determine harshness of operation may include temperatures, pressures, and/or levels of various fluids, such as engine oil, hydraulic fluid, coolant, etc. For example, suspension pressure (e.g., within shocks or struts of machine 12) may be monitored to determine a payload being transported by a hauling vehicle, such as machine 12. Payload data may provide insight into wear and tear on machine 12, and thus the harshness of operation. Alternatively or additionally, suspension pressure could be monitored to determine the roughness of terrain over which machine 12 travels, which may be yet another indicator of the harshness with which machine 12 is utilized.

Machine 12 may also be equipped with one or more atmospheric sensors 36 to monitor other types of operating conditions of machine 12. For example, atmospheric conditions, such as temperature, humidity, precipitation, etc. may be monitored. Other atmospheric conditions may also be monitored, such as dust and other particulates in the air. These and other types of atmospheric conditions may indicate harshness of operation.

Other operating conditions that may be monitored may include geographic parameters, such as information about geographic location. For example, machine 12 may be equipped with a positioning device or system (not shown). One such system may be configured for tracking machine 12 via a global positioning system (GPS). Other geographic parameters may also be monitored such as elevation at a worksite and/or incline of surfaces over which machine 12 may travel.

Directly monitoring operation of components and/or systems of machine 12 may provide a direct indication of the harshness with which machine 12 is operated. For example, monitoring repetitions of work implement operation may provide a direct indication of wear and tear on a work implement, and thus the harshness of operation of machine 12. Harshness may also be indicated indirectly, such as by monitoring other types of operating conditions like atmospheric conditions and geographic parameters. For example, atmospheric conditions like humidity, and geographic parameters like altitude may provide indirect indications of harshness of operation.

It should also be noted that more than one of these types of operating conditions may be monitored. For example, machine 12 may be equipped to monitor any combination of operating parameters, geographic parameters, and atmospheric conditions.

Controller 16 may be located anywhere on machine 12 and may include any type of processing device suitable for receiving data from data collection devices 14. Controller 16 may also be configured to facilitate offloading of the data to a location remote from machine 12.

In addition to controller 16, system 10 may include means for offloading data from machine 12. Such means may include a hardware interface device 18 configured to interface with controller 16 or directly with data collection devices 14 to download or otherwise retrieve data from machine 12. For example, hardware interface device 18 may include a laptop or personal digital assistant (PDA) configured to “plug in” to machine 12.

Alternatively or additionally, system 10 may include an over-the-air transmission receiving device 20 configured to retrieve data from machine 12 via “wireless” communication. For example, over-the-air transmission receiving device 20 may include a laptop or PDA configured to retrieve data from machine 12 via a wireless network or Internet connection. In other embodiments, system 10 may be configured to retrieve data from machine 12 from a location remote from machine 12. For example, system 10 may include a satellite 38 configured to receive data from machine 12 and redirect it to a processing center 39 remote from machine 12. Processing center 39 may be located at any distance or location relative to machine 12. For example, processing center 39 may be located at the same work site as machine 12 or at a location remote from the work site.

Although various means and methods for offloading data from machine 12 are described herein, these means and methods are exemplary only. The offloading of data from machine 12 may be accomplished in any suitable manner with any suitable means for doing so.

Whether data is retrieved from machine 12 via hardware interface device 18, over-the-air transmission receiving device 20, or some combination thereof, the retrieved data may be directed to a processor 40. In some embodiments processor 40 may be located on machine 12. In other embodiments, processor 40 may be located remote from machine 12 and at the work site where machine 12 is located. In other embodiments, processor 40 may be located remote from the work site where machine 12 is located. For example, Processor 40 may be integrated with controller 16 on machine 12, integrated with hardware interface device 18, or may be located at processing center 39, which, as described above, can be located at the work site or remote from the work site.

Data collection devices 14 may be configured to monitor operating conditions of machine 12 in real time. For purposes of this disclosure, the term “real time” shall refer to the immediate or substantially immediate availability of data to an information system as a transaction or event occurs. That is, data may be retrieved and available for analysis as quickly as it can be transmitted from machine 12 to processor 40. Such transmissions may be virtually instantaneous or may take a few seconds or minutes to complete. The recording and/or processing of such data may be performed at predetermined intervals, which, in some embodiments may be so short (e.g., on the order of milliseconds) that the recording and/or processing is virtually instantaneous and continuous.

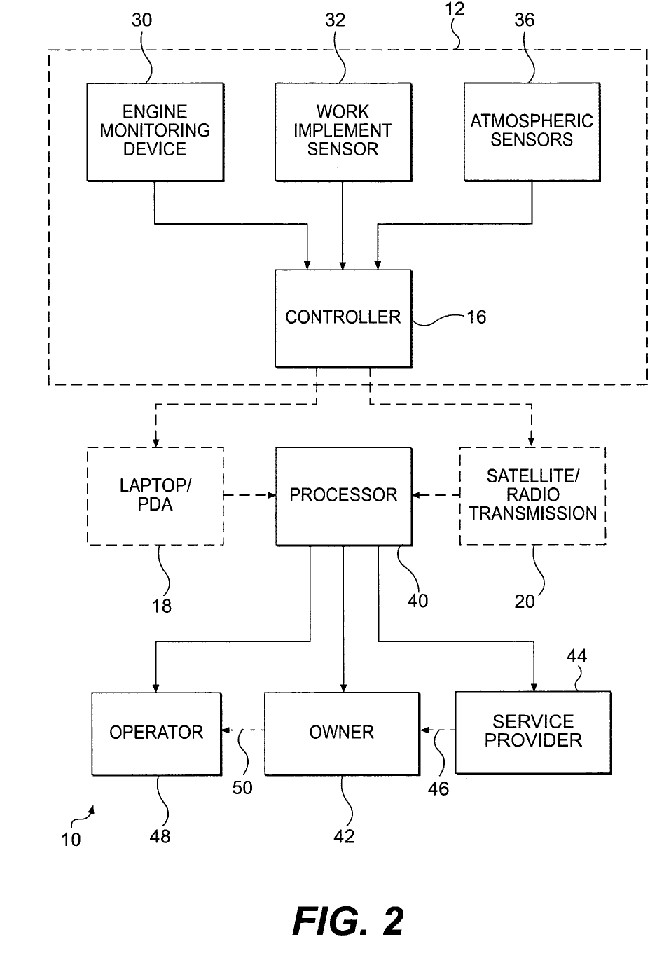

FIG. 2 is a block diagram representation of the flow of data through the various components of system 10. As illustrated by FIG. 2, data may be transmitted from various monitoring equipment, such as engine monitoring device 30, work implement sensor 32, and atmospheric sensors 36, to controller 16. The data may then be transmitted from controller 16 to processor 40 via either hardware interface device 18, over-the-air transmission receiving device 20, or some combination thereof. Processor 40 may reside with or may be otherwise associated with a service contract provider.

Processor 40 may analyze the acquired data. Alternatively or additionally, processor 40 may make information regarding the data available for consideration by one or more entities. Such information may include the acquired data, analysis thereof, or any other information relating to data or that may otherwise be desired by an interested party, such as an owner, operator, service provider, etc. For example, as illustrated in FIG. 2, the information may be forwarded to an owner 42 of machine 12. As used herein, the term owner is intended to broadly cover any person/entity that has rights or interest of any type in the machine at issue, such as, for example, a person with ownership rights (e.g., title) of such machine, a renter or lessee of such machine, a supervisor of the machine operator, or a manager of a worksite at which the machine is operated.

Alternatively or additionally, the information may be forwarded to a service provider 44. The information may be forwarded directly from processor 40 to owner 42, as shown, or from service provider 44 to owner 42 as indicated by a dashed line 46.

In some embodiments, system 10 may be configured to make the information available to at least one entity other than owner 42. In some embodiments this can be done automatically. One such entity may include an operator 48. It should be noted that owner 42 and operator 48 could be different persons or entities, as illustrated in FIG. 2, or the same person or entity. It should also be noted that the information may be transmitted directly from processor 40 to operator 48. Alternatively or additionally, the information may be transmitted from owner 42 to operator 48, as indicated by a dashed line 50.

Processor 40 may be configured to receive data from the one or more data collection devices perform an analysis of the received data as it relates to a set of usage terms of a service contract relating to machine 12. The analysis may include making a comparison between the received data and the set of usage terms of the service contract relating to machine 12. System 10 may be configured to communicate at least one of data received from the one or more data collection devices and the analysis of the received data to at least one location remote from machine 12. Such a location may include any location remote from machine 12, such as processing center 39. Processing center 39 may be associated with one or more entities, such as an owner, service provider, service contract provider, etc.

System 10 may also be configured to communicate to at least one of an owner and an operator, information regarding at least one of the received data and the analysis of the received data. In some embodiments, system 10 may be configured to communicate analysis of the received data to at least one of an owner and an operator of the machine, wherein the analysis includes recommendations. Exemplary recommendations may include suggestions for maintenance, one or more operating parameters, and/or one or more operating techniques. In other embodiments the communicated information may include an offer of an opportunity to modify the set of usage terms of the service contract. Any of these communications may be performed in real time.

### INDUSTRIAL APPLICABILITY

The disclosed asset management system may be applicable for management of any kind of mechanical equipment asset for which operating data may be retrieved. For example, the disclosed system may be used for management of machines, such as heavy duty equipment (e.g., excavators, track-type tractors, loaders, power generation sets, etc.) and/or light duty equipment (e.g., passenger vehicles, small-sized electric generators, lawn and garden tractors, etc.). Further, the disclosed system may be used to manage a fleet of one or more different types of machines.

The disclosed system may be utilized for on-site monitoring of machines at a worksite. Data may be retrieved and analyzed on location at the worksite. Alternatively or additionally, the disclosed system may be utilized for monitoring of machines from a remote location. Data may be analyzed at a processing center remote from the machine, such as a service or management center. For such remote analysis, the data may be retrieved on location at the worksite or delivered to processing center via a data transfer link (e.g., satellite communication). Alternatively or additionally, the analysis may be performed on machine 12.

The retrieved data may be examined by an individual (e.g., an owner, operator, service technician, etc.) or by the disclosed system itself to monitor any of a number of operating parameters. In an exemplary method of use, system 10 may be utilized to process this data and make a comparison between the received data and a set of usage terms of a service contract relating to machine 12.

An exemplary method of using the disclosed system may include monitoring and collecting data for one or more operating parameters of the machine. In some embodiments, the method may include monitoring and collecting data for operating parameters of the machine, geographic parameters, and/or atmospheric conditions.

An exemplary method of using the disclosed system may include making data and/or analysis available to an owner and/or an operator of the machine. For example, alerts or warnings may be provided to the owner and/or operator to make them aware of any use of the machine that was not covered by the service contract. Such alerts, particularly those sent to the operator, could be used to promote use in compliance with the service contract. Such alerts may be displayed on the machine in some fashion readily accessible by the operator, such as a display (not shown) at the operator station. In some embodiments, the service contract provider may be pre-authorized to assess fees and/or make changes to the terms of the service contract (e.g., payments and/or other usage terms). The alerts could be used to notify the operator of changes that have been made to the terms of the service contract as a result of operation not in compliance with the original agreement. The alerts may also notify the operator of any fees or changes to the cost of the service contract associated with the changed contract terms.

For example, if an original service contract provides for 160 hours of use for each month in exchange for a monthly payment of $2000, and data acquisition indicates that a user utilized the machine for 200 hours in a month, changes may be made to the service contract. The adjusted agreement may set the maximum allowable hours to 225 and increase the monthly payments to $3000. Such changes may be preceded by warnings, fees, and/or other deterrents.

In some embodiments such changes may be made automatically. For example, in embodiments where the service contract provider is pre-authorized to make changes to the service contract, system 10 may be configured to assess fees and/or make changes to the terms of the contract, in response to various triggers, e.g. violation of terms of the service contract without additional user input. The changes, warnings, fees, and any other details regarding the service contract may be communicated to the owner and/or operator. In some embodiments, such communication may be in real time.

An exemplary method of using system 10 may include communicating information and/or analysis of the received data to at least one of an owner and an operator of machine 12, wherein the analysis includes one or more recommendations. For example, such recommendations may include suggestions for maintenance, one or more operating parameters, and/or one or more operating techniques. In some embodiments, communicating information may include conveying an offer of an opportunity to modify the set of usage terms of the service contract.

It will be apparent to those having ordinary skill in the art that various modifications and variations can be made to the disclosed asset management system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. An asset management system, comprising:
one or more data collection devices configured to monitor one or more operating conditions of a machine in real time; and
a processor configured to:
receive data from the one or more data collection devices; and
perform an analysis of the received data as it relates to a set of usage terms of a service contract relating to the machine;
wherein the system is configured to:
communicate, in real time, at least one of data received from the one or more data collection devices and the analysis of the received data to at least one location remote from the machine; and
communicate, in real time, to at least one of an owner and an operator, information regarding at least one of the received data and the analysis of the received data.

2. The system of claim 1, wherein the analysis includes making a comparison between the received data and the set of usage terms of the service contract relating to the machine.

3. The system of claim 1, wherein the one or more operating conditions includes operating parameters of the machine.

4. The system of claim 1, wherein the one or more operating conditions includes at least two of the following:
operating parameters of the machine;
geographic parameters; and
atmospheric conditions.

5. The system of claim 1, wherein the one or more operating conditions includes at least one of the following:
work implement repetitions;
work implement speed; and
work implement load.

6. The system of claim 1, wherein the one or more operating conditions includes at least one of the following:
fluid temperature;
fluid pressure; and
fluid level.

7. The system of claim 1, wherein the one or more operating conditions includes at least one of the following:
payload; and
roughness of terrain.

8. The system of claim 1, wherein the system is configured to communicate analysis of the received data to at least one of an owner and an operator of the machine, wherein the analysis includes recommendations for at least one of the following:
maintenance;
one or more operating parameters; and
one or more operating techniques.

9. The system of claim 1, wherein the communicated information includes an offer of an opportunity to modify the set of usage terms of the service contract.

10. The system of claim 1, wherein the system is configured to automatically change one or more of the usage terms of the service contract.

11. The system of claim 9, wherein the communicated information includes a notification of the change in the one or more usage terms of the service contract.

12. The system of claim 1, wherein the processor is located on the machine.

13. A method of asset management, comprising:
monitoring one or more operating conditions of a machine in real time; and
receiving data from the one or more data collection devices;
performing an analysis of the received data including making a comparison between the received data and a set of usage terms of a service contract relating to the machine;
communicating, in real time, at least one of the data received from the one or more data collection devices and the analysis of the received data to at least one location remote from the machine; and
communicating, in real time, to at least one of an owner and an operator, information regarding at least one of the received data and the analysis of the received data.

14. The method of claim 13, wherein the one or more operating conditions includes operating parameters of the machine.

15. The method of claim 13, wherein the one or more operating conditions includes at least two of the following:
operating parameters of the machine;
geographic parameters; and
atmospheric conditions.

16. The method of claim 13, wherein the one or more operating conditions includes at least one of the following:
work implement repetitions;
work implement speed; and
work implement load.

17. The method of claim 13, wherein the one or more operating conditions includes at least one of the following:
fluid temperature;
fluid pressure; and
fluid level.

18. The method of claim 13, wherein the one or more operating conditions includes at least one of the following:
payload; and
roughness of terrain.

19. The method of claim 13, further including communicating analysis of the received data to at least one of an owner and an operator of the machine, wherein the analysis includes recommendations for at least one of the following:
maintenance;
one or more operating parameters; and
one or more operating techniques.

20. The method of claim 13, further including communicating information regarding the received data to at least one of an owner and an operator of the machine, wherein the information includes an offer of an opportunity to modify the set of usage terms of the service contract.

21. The method of claim 13, further including automatically changing one or more of the usage terms of the service contract.

22. The method of claim 21, wherein the communicated information includes a notification of the change in the one or more usage terms of the service contract.

23. The method of claim 13, wherein the analysis is performed on the machine.

24. A machine, comprising:
a frame; and
a power source mounted to the frame;
wherein the machine is integrated with an asset management system including:
one or more data collection devices configured to monitor one or more operating conditions of a machine in real time; and
a processor configured to:
receive data from the one or more data collection devices; and
perform an analysis of the received data including making a comparison between the received data and a set of usage terms of a service contract relating to the machine;
wherein the system is configured to:
communicate, in real time, at least one of the data received from the one or more data collection devices and the analysis of the received data to at least one location remote from the machine; and
communicate, in real time, to at least one of an owner and an operator, information regarding at least one of the received data and the analysis of the received data.

25. The machine of claim 24, wherein the one or more operating conditions includes operating parameters of the machine.

26. The machine of claim 24, wherein the one or more operating conditions includes at least two of the following:
operating parameters of the machine;
geographic parameters; and
atmospheric conditions.

27. The machine of claim 24, wherein the one or more operating conditions includes at least one of the following:
work implement repetitions;
work implement speed; and
work implement load.

28. The machine of claim 24, wherein the one or more operating conditions includes at least one of the following:
fluid temperature;
fluid pressure; and
fluid level.

29. The machine of claim 24, wherein the one or more operating conditions includes at least one of the following:
payload; and
roughness of terrain.

30. The machine of claim 24, wherein the system is configured to communicate analysis of the received data to at least one of an owner and an operator of the machine, wherein the analysis includes recommendations for at least one of the following:
maintenance;
one or more operating parameters; and
one or more operating techniques.

31. The machine of claim 24, wherein the communicated information includes an offer of an opportunity to modify the set of usage terms of the service contract.

32. The machine of claim 24, wherein the system is configured to automatically change one or more of the usage terms of the service contract.

33. The machine of claim 32, wherein the communicated information includes a notification of the change in the one or more usage terms of the service contract.

34. The machine of claim 24, wherein the processor is located on the machine.
